(19) United States
(12) Patent Application Publication
(10) Pub. No.: US 2018/0232903 A1
(43) Pub. Date: Aug. 16, 2018

(54) ESTIMATION DEVICE, ESTIMATION METHOD, AND STORAGE MEDIUM

(71) Applicant: Panasonic Intellectual Property Management Co., Ltd., Osaka (JP)

(72) Inventor: KYOKO KAWAGUCHI, Tokyo (JP)

(21) Appl. No.: 15/872,015

(22) Filed: Jan. 16, 2018

(30) Foreign Application Priority Data
Feb. 16, 2017 (JP) 2017-027230

(51) Int. Cl. G06T 7/70; G06K 9/66

(52) U.S. Cl. CPC G06T 7/70; G06T 2207/30196; G06T 2207/30268; G06K 9/66

(57) ABSTRACT

An estimation device includes a storage section, an estimator, a likelihood calculator, and an output section. The storage section stores a model formed through machine learning. The estimator estimates a skeleton location of a specific part of a vehicle-occupant and a positional relation between equipment and the specific part, from image data containing an image of the equipment in a vehicle interior with the aid of the model stored in the storage section. The output section outputs the skeleton location information.

### BACKGROUND

### 1. Technical Field

The present disclosure relates to an estimation device and an estimation method for estimating a skeleton location of a vehicle-occupant (e.g. driver) in an interior of a vehicle, and it also relates to a storage medium for storing an estimation program.

### 2. Description of the Related Art

In recent years, information-providing techniques useful for vehicle-occupants in mobile devices (e.g. in an interior of a vehicle including such as a car) have been developed. According to these techniques, the state of the vehicle-occupant (action or gesture) in a mobile device is sensed, and the vehicle-occupant is provided with useful information based on the result of sensing. Some of these techniques are disclosed in Unexamined Japanese Patent Publication No. 2014-221636, and No. 2014-179097.

A technique for sensing a state of the vehicle-occupant is actualized in, for instance, an estimation device that estimates the skeleton location of the specific part of the vehicle-occupant based on an image supplied from an in-vehicle camera disposed in the vehicle interior. The skeleton location can be estimated with the aid of an estimating model (algorithm) formed through a machine learning. The estimating model formed through a deep learning, in particular, is suited for this application because of its high estimation accuracy about the skeleton location. The deep learning refers to a type of the machine learning using a neural network.

### SUMMARY

The present disclosure provides an estimation device and estimation method that improve a sensing accuracy of a state of the vehicle-occupant, and a storage medium that stores an estimation program.

The estimation device of the present disclosure includes a storage section, an estimator, a likelihood calculator, and an output section. The storage section stores a model formed through a machine learning. The estimator estimates a skeleton location of a specific part of a vehicle-occupant in a vehicle interior from image data, in which the equipment in the interior is shot, with the aid of the model stored in the storage section, and this estimator also estimates a positional relation between the equipment and the specific part. The likelihood calculator calculates the likelihood of skeleton location information, which indicates the skeleton location, based on the estimated positional relation. The output section outputs the skeleton location information.

According to the estimation method of the present disclosure, image data in which the equipment in a vehicle interior is shot is obtained first. Consequently, a skeleton location of a specific part of a vehicle-occupant in the vehicle interior and a positional relation between the equipment and the specific part from the obtained image data are estimated with the aid of the model stored in the storage section;. Further, a likelihood of skeleton location information indicating the skeleton location is calculated based on the estimated positional relation, then the skeleton location information is output.

A non-transitory storage medium of the present disclosure stores an estimation program to be executed by a computer of the estimation device. This estimation program includes the following processes:

1. making the computer obtain image data in which the equipment in the vehicle interior is shot;

2. making the computer estimate the skeleton location of a specific part of a vehicle-occupant in the vehicle interior, and the positional relation between the equipment and the specific part from the obtained image data with the aid of the model stored in the storage section;

3. making the computer calculate a likelihood of skeleton location information indicating the skeleton location based on the estimated positional relation; and

4. making the computer output the skeleton location information.

The present disclosure allows improving the accuracy of sensing the state of the vehicle-occupant.

### BRIEF DESCRIPTION OF DRAWINGS

FIG. 1 shows an example of an estimation device.

FIGS. 2A and 2B show an example of a method for determining a likelihood of a skeleton location estimated by an estimation device.

FIG. 3 shows an estimation device in accordance with an embodiment of the present disclosure.

FIG. 4 shows an example of a learning device that forms an estimating model.

FIG. 5 is a flowchart of an example of a learning process to be executed by a processor of a learning device.

FIG. 6 is a flowchart of an example of an estimating process to be executed by a processor of an estimation device.

FIG. 7 shows an example of a method for calculating the likelihood based on an estimation result.

FIG. 8 shows another example of a method for calculating the likelihood based on the estimation result.

FIG. 9 shows an example of a determination result of a positional relation based on estimated skeleton-location information of a specific part and individual-equipment information.

FIGS. 10A and 10B show an example of an estimation result, estimated by an estimating model, of a positional relation between the specific part and the equipment, and an example of a determination result of determining the positional relation between the specific part and the equipment based on skeleton-location information and equipment information.

FIG. 11 shows another estimation device in accordance with the embodiment of the present disclosure.

### DETAILED DESCRIPTION OF PREFERRED EMBODIMENTS

Prior to the description of the embodiment of the present disclosure, the origin of the present disclosure is explained.

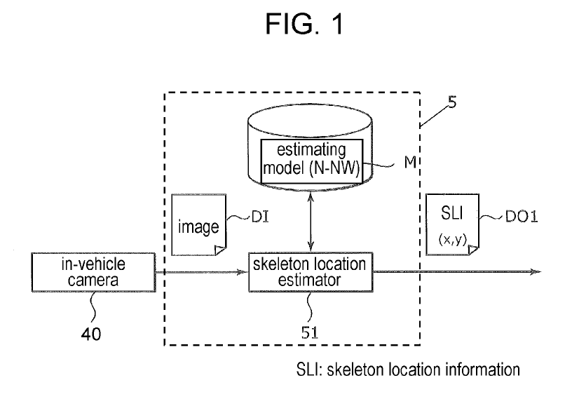

FIG. 1 schematically shows a structure of estimation device 5 as an example. Estimation device 5 includes skeleton location estimator 51, which estimates a skeleton location, with the aid of estimating model M, of a specific part (e.g. hand, shoulder) of a vehicle-occupant contained in image DI supplied from in-vehicle camera 40, and outputs skeleton location information DO1. Estimating model M is formed through a machine learning that uses training data (or it is referred to as a teacher data). In this training data, an image to be input (problem) is associated with a skeleton location to be output (solution). Information DO1 is given as coordinates (x, y) indicating the skeleton location of the specific part in image DI.

Some pieces of the equipment disposed in the interior of vehicle have shapes similar to specific parts of the vehicle-occupant. For instance, an outer edge of seat and an unevenness of the door are similar to an arm and a hand of the vehicle-occupant. They are thus difficult to distinguish from each other in the image. In this case, it is afraid that an estimation result obtained with the aid of the estimating model might show a wrong result, viz. the result indicates a wrong skeleton location. As a result, a state of the vehicle-occupant is sensed based on the skeleton location erroneously estimated, so that a correct sensing result cannot be obtained.

In the case of estimating a state of the vehicle-occupant with the aid of the estimating model formed through the machine learning and based on the skeleton location of the specific part of the vehicle-occupant, it is preferable that an estimation result (skeleton location information) of a weak likelihood be excluded and an estimation result of a strong likelihood be only used for sensing the state of the vehicle-occupant. Nevertheless, in the case of estimating the skeleton location with the aid of the estimating model, the most likelihood value for an image of one frame is output as an estimation result. In other words, a conventional estimation device outputs always a 100% likelihood of an estimation result (skeleton location information). When a state of the vehicle-occupant is sensed, it is thus difficult, based on the likelihood resulting from the estimation, to determine whether or not the estimation result is usable.

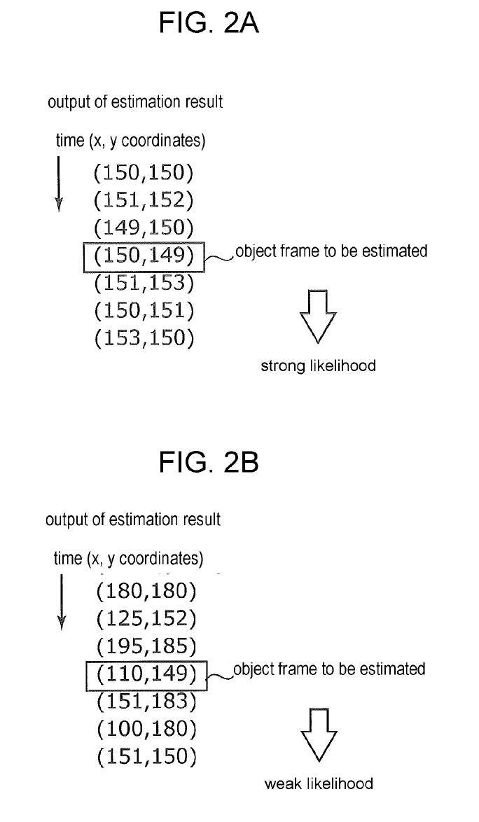

On the other hand, the likelihood of an estimation result of an object frame to be estimated can be calculated based on estimation results of images of multiple frames. For instance, as FIGS. 2A and 2B show, when a comparison result of estimation results between the object frame to be estimated and the frames before and after the object frame (in FIGS. 2A and 2B, three frames before the object frame and three frames after the object frame) shows almost no difference, it is determined that the likelihood is strong (a probability of a right estimation result is high). This is the case shown in FIG. 2A. On the other hand, when the estimation result is unstable, it is determined that the likelihood is weak (a probability of a wrong estimation result is high). This is the case shown in FIG. 2B.

Nevertheless, as shown in FIGS. 2A and 2B, in the case of calculating the likelihood by using the estimation result of the frame after the object frame, the calculation is forced to have a delay because of waiting for the estimation result of the frame after the object frame. The present disclosure thus introduces a new calculating method for the likelihood, and senses a state of vehicle-occupant with the aid of the highly accurate estimation result.

The exemplary embodiment of the present disclosure is demonstrated hereinafter with reference to the accompanying drawings.

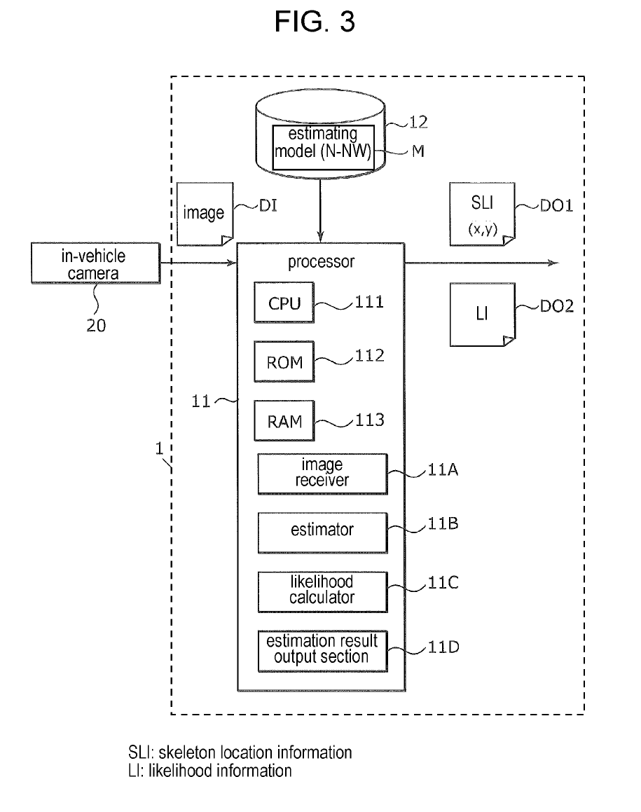

FIG. 3 shows estimation device 1 in accordance with the embodiment. FIG. 3 particularly details a function block and hardware of estimation device 1. Estimation device 1 is mounted to a vehicle, and estimates a skeleton location of a specific part of a vehicle-occupant based on image DI shot by in-vehicle camera 20. Image DI contains an image of the specific part of the vehicle-occupant in the interior of the vehicle. Estimation device 1 also estimates a positional relation between the equipment disposed in the interior and the specific part of the vehicle-occupant. The estimated positional relation is used when a likelihood of the estimated skeleton location is determined (or calculated).

In-vehicle camera 20 is, for example, an infrared camera disposed in the interior of the vehicle. In-vehicle camera 20 shoots a seated vehicle-occupant and a region in which the equipment around the vehicle-occupant is present. Estimation device 1 estimates a positional relation between the specific part of the vehicle-occupant and pieces of equipment among the equipment around the vehicle-occupant. Each of the pieces of equipment has a shape similar to the specific part of the vehicle-occupant. In other words, estimation device 1 estimates the positional relation between the specific part of the vehicle-occupant and each of the pieces of equipment that is difficult to distinguish from the specific part in the image. For instance, in the case of the specific part being a hand of the vehicle-occupant, the positional relation between the hand and the equipment such as a door, steering wheel, or seatbelt is estimated.

In the case of estimating the skeleton location of the right hand of the vehicle-occupant with estimation device 1, how to determine a likelihood of the estimated skeleton location is demonstrated hereinafter. This determination uses estimation results of a positional relation between the right hand and the door, a positional relation between the right hand and the steering wheel, and a positional relation between the right hand and the seatbelt.

As FIG. 3 shows, estimation device 1 includes processor 11 and storage section 12.

Processor 11 includes CPU (central processing unit) 111 working as computation/control device, ROM (read only memory) 112 working as a main storage device, and RAM (random access memory) 113. ROM 112 stores a basic program called BIOS (basic input output system) and basic setting data. CPU 111 reads a program from ROM 112 or storage section 12 in response to a processing content, and then develops the program in RAM 113 for executing the developed program, thereby executing a given process.

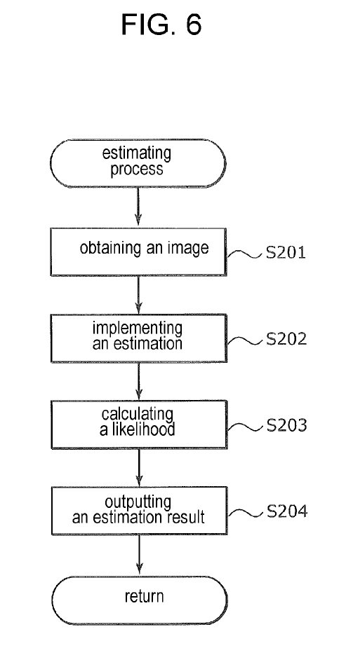

Processor 11, for instance, executes an estimation program, thereby working as image receiver 11A, estimator 11B, likelihood calculator 11C, and estimation result output section 11D. To be more specific, processor 11 estimates a skeleton location of the vehicle-occupant (herein, skeleton location of the right hand) from the image data containing an image of the equipment of the vehicle with the aid of estimating model M. The equipment of the vehicle includes such as a door, steering wheel, seatbelt, rear-view mirror, sunshade, center-panel, car navigation system, air-conditioner, shift lever, center-box, dashboard, arm-rest, and seat. The image data containing the image of the equipment of the vehicle is supplied from in-vehicle camera 20 to processor 11, which then estimates the positional relation between the equipment and the specific part of the vehicle-occupant before outputting the estimation result. The functions of image receiver 11A, estimator 11B, likelihood calculator 11C, and estimation result output section 11D will be described following the flowchart shown in FIG. 6. In the descriptions below, the image data is sometimes referred to simply as an image.

Storage section 12 is an auxiliary storage device such as HDD (hard disk drive) and SSD (solid state drive). Storage section 12 can be a disc drive that drives an optical disc such as a CD (compact disc), DVD (digital versatile disc) and an MO (magneto-optical disc) to read/write information. Storage section 12 can be also a USB memory or a memory card such as an SD card.

Storage section 12, for instance, stores an operating system (OS), an estimation program, and estimating model M. The estimation program can be stored in ROM 112. The estimation program is provided via a portable and computer readable storage medium (e.g. optical disc, magneto-optical disc, and memory card) that has stored the program. The estimation program can be also supplied by downloading the program from a server device via a network. Estimating model M can be stored in ROM 112, and can be supplied through the portable storage medium or a network as well. The portable storage medium is a non-transitory computer readable storage medium.

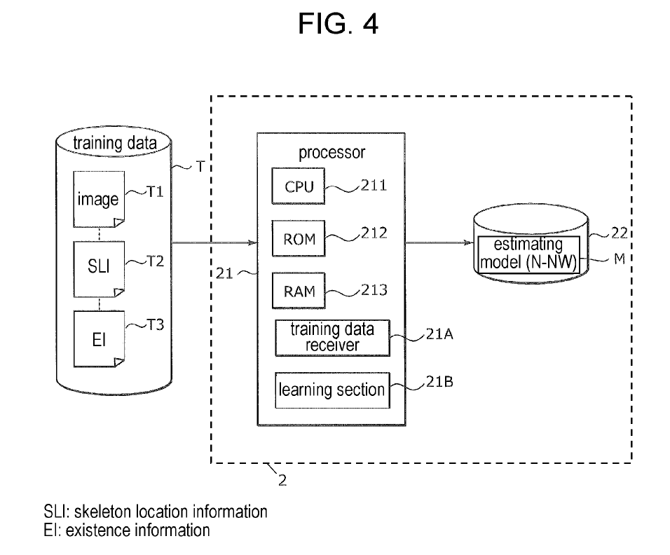

Estimating model M is an algorithm formed through machine learning, and outputs skeleton location information that indicates the skeleton location of the specific part of the vehicle-occupant, and existence information that indicates a positional relation between the equipment and the specific part, upon receiving the image containing the image of the equipment. Estimating model M is preferably formed through deep learning that uses a neural network. Estimating model M thus formed has the higher performance of image recognition, and thus can estimate the positional relation between the equipment and the specific part of the vehicle-occupant with high accurate. Estimating model M is formed, for instance, by learning device 2 shown in FIG. 4.

FIG. 4 shows an example of learning device 2 to form estimating model M. Learning device 2 includes processor 21 and storage section 22. Processor 21 includes CPU 211, ROM 212, and RAM 213. Some of these elements have the same structures as those of processor 11 and storage section 12 of estimation device 1, so that the descriptions of the structures common to both are omitted here.

Processor 21, for instance, executes a learning program thereby functioning as training data receiver 21A and learning section 21B. To be more specific, processor 21 carries out ‘a learning with teacher’ with the aid of training data T, thereby forming estimating model M.

Training data T includes image T1, skeleton location information T2, and existence information T3. Image T1 contains images of the equipment (door, steering wheel, and seatbelt) of the vehicle and the specific part of the vehicle-occupant. Information T2 indicates the skeleton location of the specific part of the vehicle-occupant shot in image T1. Information T3 indicates the positional relation between the equipment and the specific part. Image T1 is associated with information T2 and T3, and this unit (i.e. T1, T2, and T3) as one set forms training data T. Image T1 is an input to estimating model M, and information T2 and T3 are output from estimating model M. Image T1 can contain only the image of the equipment (not containing the specific part of the vehicle-occupant).

Skeleton location information T2 is given as coordinates (x, y) indicating the skeleton location of the specific part in image T1.

Existence information T3 is given as ‘True/False’. To be more specific, when existence information T3 is given as ‘True’, information T3 indicates that the hand is overlaid upon the equipment (the hand touches the equipment). On the other hand, when existence information T3 is given as ‘False’, information T3 indicates that the hand is off the equipment. In this context, existence information T3 includes the first individual-equipment existence information indicating the positional relation between the right hand and the door, the second individual-equipment existence information indicating the positional relation between the right hand and the seat, and the third individual-equipment existence information indicating the positional relation between the right hand and the seatbelt.

The specific part of the vehicle-occupant will not touch two different equipment simultaneously. To be more specific, the right hand cannot touch a door and a steering wheel simultaneously, because the door is apart from the steering wheel by a greater distance than a size of one hand. Accordingly, when one piece of the three individual-equipment existence information of existence information T3 is set to ‘True’, the other two are set to ‘False’.

Image T1 of training data T can be an entire image corresponding to the complete image shot by in-vehicle camera 20, or it can be a partial image corresponding to an image cut out from the entire image. In the case of using the image, shot by in-vehicle camera 20, as it is as an input of estimating model M used in estimation device 1, the entire image is prepared as image T1 of training data T, and skeleton location information T2 is given as the coordinates on the entire image. When estimation device 1 uses the image cut out from the image shot by in-vehicle camera 20 as an input to estimating model M, the partial image is prepared as image T1 of training data T, and skeleton location information T2 is given as the coordinates on the partial image. In other words, image T1 of training data T during the learning preferably has the same object range to be processed (image size and location) as the object range of the image to be used as the input to estimating model M during the estimation.

Image T1 of training data T contains images of various patterns supposed to be shot by in-vehicle camera 20. To be more specific, a large amount of images showing the vehicle-occupant in different states, viz. specific parts in different locations, are prepared as image T1 of training data T. Then skeleton location information T2 and existence information T3 are associated with each of a large amount of the images. Preparation of patterns as many as possible as image T1 will increase an accuracy of the estimation done by estimating model M.

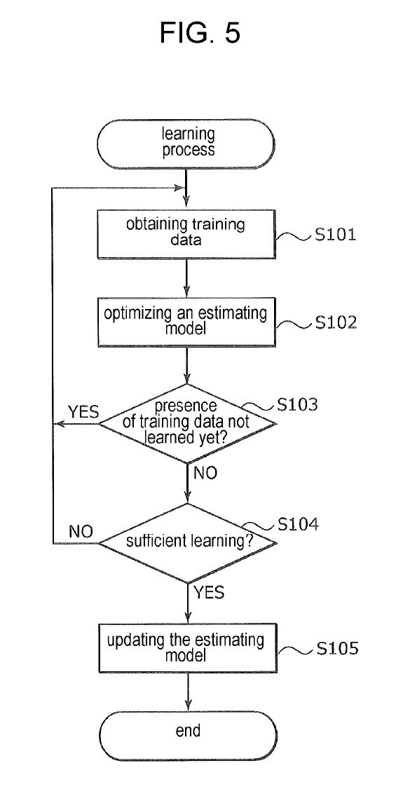

FIG. 5 is a flowchart showing an example of a learning process executed by processor 21 of learning device 2. This process is actualized through an execution of the learning program by CPU 211.

In step S101, processor 21 obtains one set of training data T. Processor 21 executes the process as training data receiver 21A. As discussed previously, training data T contains image T1, skeleton location information T2, and existence information T3.

In step S102, processor 21 optimizes estimating model M based on obtained training data T. Processor 21 executes the process as learning section 21B. To be more specific, processor 21 reads the present estimating model M from storage section 22. Processor 21 then modifies or reforms estimating model M such that an output, produced when image T1 is input to estimating model M, becomes equal to the values of skeleton location information T2 and existence information T3 both associated with image T1. For instance, during a deep learning with the aid of a neural network, a binding strength (parameter) between nodes that form the neural network is modified.

In step S103, processor 21 determines whether or not training data T not yet learned is present. In the case where training data T not yet learned is found (branch YES of step S103), the process moves to step S101, so that the learning of estimating model M is repeated, and the accuracy of estimating model M can be increased, viz. estimating accuracies of the skeleton location of the vehicle-occupant and the positional relation between the skeleton location of the specific part and the equipment are increased. On the other hand, in the case where training data T not yet learned is not found (branch NO of step S103), the process moves to step S104.

In step S104, processor 21 determines whether or not the learning is fully done. For instance, processor 21 uses an average value of square-error as a loss function, and when this value is equal to or less than a predetermined threshold, processor 21 determines that the learning has been fully done. To be more specific, processor 21 calculates the average values of respective square-errors between the output values used in step S102 and produced when image T1 is input into estimating model M, and the values of skeleton location information T2 and existence information T3 both associated with image T1, then processor 21 determines whether or not each of those average values is equal to or less than the respective predetermined threshold.

When processor 21 determines that the learning has been fully done (branch YES in step S104), the process moves to step S105. When processor 21 determines that the learning is not fully done yet (branch NO in step S104), processor 21 repeats the processes from step S101 and onward.

In step S105, processor 21 updates estimating model M stored in storage section 22 based on the result of learning.

As discussed above, learning device 2 forms estimating model M to be used for estimating the skeleton location of the vehicle-occupant in the interior of the vehicle. Learning device 2 includes training data receiver 21A (a receiver) and learning section 21B. Training data receiver 21A obtains training data T, in which image T1 containing an image of at least one piece of the equipment in the interior is associated with skeleton location information T2 (first information) indicating the skeleton location of the specific part of the vehicle-occupant and existence information T3 (second information) indicating the positional relation between the equipment and the specific part. The at least one piece of the equipment in the interior refers to, for instance, a door, a steering wheel, or a seatbelt. The specific part of the vehicle-occupant refers to, for instance, a right hand. Learning section 21B forms estimating model M such that an input of image T1 to estimating model M allows outputting skeleton location information T2 and existence information T3, both associated with image T1, from estimating model M.

Use of estimating model M formed by learning device 2 allows estimation device 1 to estimate the skeleton location of the specific part (e.g. right hand) of the vehicle-occupant based on the image supplied from in-vehicle camera 20, as well as the positional relation between the equipment and the specific part.

FIG. 6 is a flowchart showing an example of the estimating process executed by processor 11 of estimation device 1. The execution of the estimation program with CPU 111 will implement this process. In-vehicle camera 20 feeds processor 11 with image DI frame by frame sequentially.

In step S201, processor 11 obtains image DI from in-vehicle camera 20. Processor 11 executes the process as image receiver 11A.

In step S202, processor 11 carries out an estimation of the skeleton location of the specific part of the vehicle-occupant and an estimation of the positional relation between the equipment and the specific part, based on image DI with the aid of estimating model M. Processor 11 executes the process as estimator 11B. As the estimation result obtained by estimator 11B, the skeleton location information indicating the skeleton location of the specific part, and the existence information indicating the positional relation between the specific part and the equipment are obtained. The existence information in this context contains the first individual-equipment information indicating the positional relation between the right hand and the door, the second individual-equipment information indicating the positional relation between the right hand and the seat, and the third individual-equipment information indicating the positional relation between the right hand and the seatbelt.

In step S203, processor 11 calculates a likelihood of the estimated skeleton location with the aid of the existence information. Processor 11 executes the process as likelihood calculator 11C.

For instance, processor 11 compares multiple estimation results (three pieces of information are used in this embodiment) of the individual-equipment existence information with each other, thereby calculating the likelihood of the skeleton location information. In the case of no contradiction are found among the multiple estimation results of individual-equipment existence information, the likelihood of the estimated skeleton location information is strong (e.g. likelihood is rated 1). In the case where any contradiction is found among them, the likelihood is weak (e.g. the likelihood is rated 0).

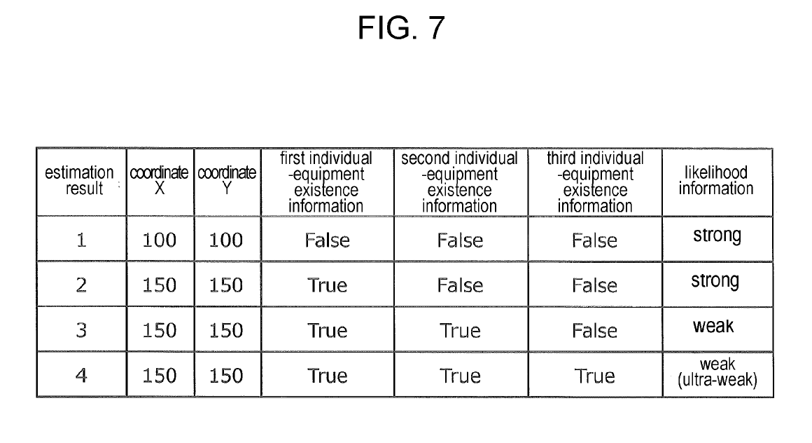

As FIG. 7 shows, when one of three estimation results of the individual-equipment existence information is given as ‘True’ (estimation result 2) or all of the three results are given as ‘False’ (estimation result 1), there is no contradiction among the estimation results. Nevertheless, when two or three results are given as ‘True’ (estimation result 3, or 4), the estimation results are contradictory to each other. In other words, at least one estimation result is wrong. If the estimation results of the individual-equipment existence information are contradictory to each other, it is difficult to identify the specific part in image DI, so that the estimated skeleton location is possibly not accurate. In such a case, the likelihood is rated ‘weak’. The likelihood can be classified more minutely in response to the degree (the number of rated ‘True’s) of contradiction among the estimation results. For instance, in FIG. 7, estimation result 4 shows a greater degree of contradiction than estimation result 3, so that the likelihood of result 4 is rated weaker than that of result 3.

As discussed above, the comparisons of the estimation results of the multiple pieces of individual-equipment existence information with each other allow readily determining the likelihood of the estimated skeleton location information.

Furthermore, when the estimation results of individual-equipment existence information have contradictions to each other (estimation results 3 and 4 in FIG. 7), the following method is also available: each of the estimation results is compared with the positional relations determined based on the equipment information indicating locations of each of the equipment and the skeleton location information, thereby calculating the likelihood of the skeleton location information.

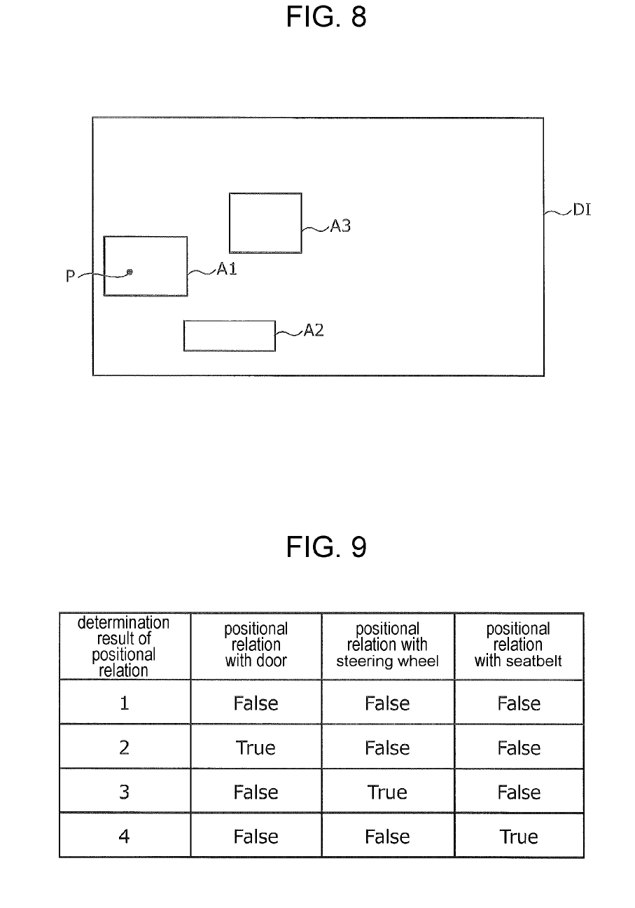

The equipment information has been established in advance and stored in ROM 112. This information is given as a region occupied by individual equipment (e.g. door, steering wheel, seatbelt) on the image. In this context, the region is given as four points in coordinates. As FIG. 8 shows, door's region A1, steering wheel's region A2, and seatbelt's region A3 are not overlaid on each other.

FIG. 8 only shows that regions A1-A3 of individual equipment are not overlaid on each other, and does not indicate the locations of individual equipment on an actual image. In the case of using a three dimensional image as the image, the equipment information can contain not only the information about coordinates (x, y) on the image, but also the information about a depth.

As FIG. 8 shows, when skeleton location P, estimated by estimating model M, of the right hand falls within region A1, it is presumed that the right hand touches the door, and the positional relation between the right hand and the door is determined as ‘True’. In this case, the positional relations between the right hand and the steering wheel, and the right hand and the seatbelt are both determined as ‘False’. In other words, as FIG. 9 shows, the positional relations determined based on the estimated skeleton location information of the specific part and the individual-equipment information are all determined as ‘False’ (determination result 1), or only one positional relation is determined as ‘True’ (determination results 2-4).

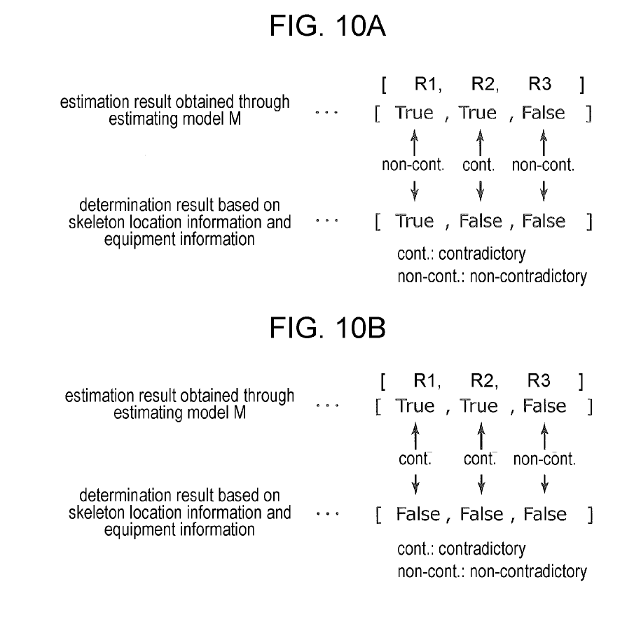

Each of FIGS. 10A and 10B shows an example of an estimation result, with the aid of estimating model M, of the positional relation between the specific part and the equipment, and an example of a determination result of the positional relation between the specific part and the equipment based on the skeleton location information and the equipment information. In each of FIGS. 10A and 10B, positional relation R1 between the right hand and the door, positional relation R2 between the right hand and the steering wheel, and positional relation R3 between the right hand and the seatbelt (R1, R2, R3=True/False) are expressed as [R1, R2, R3].

For instance, assume that estimation result 3 shown in FIG. 7 is obtained as an estimation result with the aid of estimating model M, and the determination result based on both of the skeleton location information and the equipment information is determination result 2 shown in FIG. 9, then as shown in FIG. 10A, the result of positional relation R2 between the right hand and the steering wheel incurs a contradiction. Here is another instance: estimation result 3 shown in FIG. 7 is obtained with the aid of estimating model M, and the determination result based on both of the skeleton location information and the equipment information is determination result 1 shown in FIG. 9, then as shown in FIG. 10B, the result of positional relation R1 between the right hand and the door incurs a contradiction, and the result of positional relation R2 between the right hand and the steering wheel also incurs a contradiction.

When the estimation result of the individual-equipment existence information has a contradiction (estimation results 3, 4 shown in FIG. 7), a comparison between the estimation result obtained with the aid of estimating model M and the determination result based on both of the skeleton location information and the equipment information will prove that there is at least one (max. three) contradiction. The number of the contradictions allows classifying the likelihood more minutely.

In step S204 shown in FIG. 6, processor 11 outputs, as the estimation results, skeleton location information DO1, which indicates the skeleton location of the specific part of the vehicle-occupant, and likelihood information DO2 indicating the calculated likelihood (refer to FIG. 3: processor 11 execute the process as estimation result output section 11D). The process discussed above is carried out for image DI of each frame. Skeleton location information DO1 and likelihood information DO2 both supplied as the estimation results from estimation device 1 will be used in, for instance, a state sensing device (including an application program) disposed in a later stage of estimation device 1.

The state sensing device carries out an appropriate process in response to the skeleton location of the specific part of the vehicle-occupant. For instance, when the estimation result indicates a determination that the right hand does not hold the steering wheel, the state sensing device issues a warning to hold the steering wheel. At this time, the state sensing device selects the skeleton location information having a likelihood stronger than a given value before using the information, thereby increasing a sensing accuracy, so that a proper process can be expected.

As discussed above, in step S204, processor 11 outputs skeleton location information DO1 as the estimation results for indicating the skeleton location of the specific part of the vehicle-occupant as well as likelihood information DO2 that indicates the calculated likelihood. Instead of this process, processor 11 can output only the skeleton location information having a likelihood stronger than a given value. In such a case, the state sensing device can carry out a process appropriate to the skeleton location information output from processor 11, and does not need to select the skeleton location information having a stronger likelihood.

As discussed above, estimation device 1 estimates the skeleton location of the vehicle-occupant in the interior of the vehicle, and includes storage section 12, estimator 11B, likelihood calculator 11C, and estimation result output section 11D (an output section). Storage section 12 stores estimating model M formed through machine learning. Estimator 11B obtains image DI containing an image of at least one piece of the equipment (e.g. door, steering wheel, seatbelt) in the interior, and estimates a skeleton location of a specific part of a vehicle-occupant (e.g. right hand) with the aid of estimating model M. Estimator 11B also estimates the positional relation between the equipment and the specific part with the aid of estimating model M Likelihood calculator 11C calculates a likelihood of skeleton location information DO1, which indicates the skeleton location, based on the estimated positional relation. Estimation result output section 11D outputs at least skeleton location information DO1.

The estimation method carried out in estimation device 1 estimates the skeleton location of the vehicle-occupant in the vehicle interior. According to the method, image DI containing an image of at least one piece of the equipment (e.g. door, steering wheel, seatbelt) is obtained (refer to step S201 in FIG. 6); then a skeleton location of the specific part (e.g. right hand) of the vehicle-occupant, and a positional relation between the equipment and the specific part are estimated (refer to step S203 in FIG. 6) from obtained image DI with the aid of estimating model M stored in storage section 12; further, a likelihood of skeleton location information DO1, which indicates the skeleton location, is calculated based on the estimated positional relation (refer to step S203 in FIG. 6); and at least skeleton location information DO1 is output (refer to step S204 in FIG. 6).

The estimation program to be executed by a computer of estimation device 1 includes the first-fourth processes below:
in the first process, processor 11 (i.e. computer) of estimation device 1, which estimates a skeleton location of a vehicle-occupant in the vehicle interior, executes obtaining image DI containing an image of at least one piece of the equipment (e.g. door, steering wheel, seatbelt), (refer to step S201 in FIG. 6);
in the second process the computer executes estimating the skeleton location of the specific part (e.g. right hand) of the vehicle-occupant as well as the positional relation between the equipment and the specific part, from obtained image DI with the aid of estimating model M stored in storage section 12 (refer to step S202 in FIG. 6);
in the third process, the computer executes calculating the likelihood of skeleton location information DO1, which indicates the skeleton location, based on the estimated positional relation (refer to step S203 in FIG. 6); and
in the fourth process, the computer executes outputting at least skeleton location information DO1 (refer to step S204 in FIG. 6).
   The estimation program discussed above is stored in a non-transitory storage medium for an actual use.

Estimation device 1 thus allows outputting the skeleton location information of the specific part of the vehicle-occupant as well as the information about a likelihood useful for sensing the state of the vehicle-occupant. These functions of estimation device 1 achieve an improvement in accuracy of sensing the state of the vehicle-occupant. The likelihood calculation can be carried out for an image of each frame in order to increase a recognition accuracy.

As discussed previously, the present disclosure is demonstrated specifically based on the exemplary embodiment, nevertheless the present disclosure is not limited to the embodiment and can be modified within the scope not deviating from the gist of the disclosure.

For instance, estimation device 1 can output the estimated existence information as it is as the information about the likelihood. In this case, the state sensing device disposed in a later stage of estimation device 1 determines the likelihood of the estimated skeleton-location information.

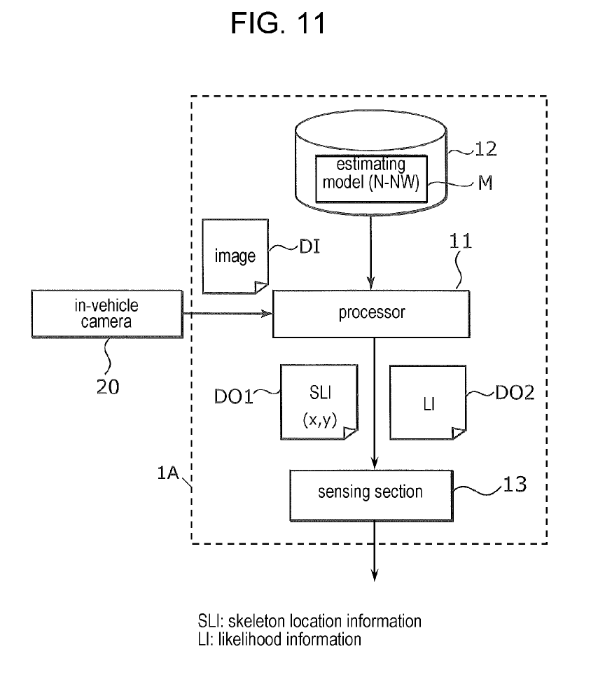

As FIG. 11 shows, the estimation device can include a sensing section, viz. estimation device 1A further includes sensing section 13 configured to sense a state (e.g. posture) of the vehicle-occupant based on both of the skeleton location information and the information about the likelihood. Sensing section 13 outputs the sensed result. In other words, estimation device 1A can work also as a state sensing device.

The specific part, of which skeleton location is estimated by estimation device 1, is not limited to ‘right hand’ demonstrated in the embodiment, but the specific part can be another part. The object equipment, of which positional relation with the specific part is to be estimated, can be one piece or two pieces of the equipment, and it can be more than three pieces of the equipment.

Estimating model M can be formed through other type of machine learning (e.g. random forest) other than the deep learning.

In this embodiment, an example of the method for calculating the likelihood in the case where a contradiction is found in the estimation results of individual-equipment existence information (e.g. a contradiction is found in estimation results 3 and 4 shown in FIG. 7) is described hereinbefore. In such a case, each estimation result of three pieces of the individual-equipment information is compared with the positional relation determined based on both of the equipment information indicating the position of the equipment and the skeleton location information, thereby calculating the likelihood of the individual-equipment existence information. Nevertheless, in the case where no contradiction is found in the estimation results of the individual-equipment existence information (e.g. in estimation results 1 and 2 shown in FIG. 7), the likelihood of the skeleton location information can be calculated by the following method: Each of estimation results of three pieces of the individual-equipment existence information is compared with the positional relation determined based on both of the equipment information indicating the position of the equipment and the skeleton location information. This method allows calculating the likelihood more accurately.

Here is another method for calculating the likelihood: An estimation result of one piece of the individual-equipment information is compared with a positional relation determined based on both of the equipment information indicating the position of the same equipment and the skeleton location information. In other words, in the case where the use of estimating model M allows estimating at least one piece of the individual-equipment existence information, the likelihood of the skeleton location information can be calculated.

Alternatively, image T1 and skeleton location information T2 are prepared as training data T to be used for the learning done in learning device 2, and existence information T3 can be produced by processor 21 of learning device 2 based on the skeleton location information and the equipment information.

In the previous description, a program is installed in a general purpose computer, thereby allowing the computer to function as processors 11 and 21; nevertheless, individual parts of processors 11 and 21 can be formed of dedicated circuits, or only portions of the individual parts can be formed of dedicated circuits and the remaining portions can be formed by installing a program into the general purpose computer.

The embodiment demonstrated hereinbefore shall be construed that every description is exemplified, and not limited to something The scope of the present disclosure is defined not in the descriptions hereinbefore but in the claims described hereinafter, and can be changed within a scope not deviating from the gist of the claims.

The present disclosure is useful for an estimation device, estimation method, and estimation program that estimate not only a skeleton location of a vehicle-occupant in a vehicle interior, but also a skeleton location of a person in a specific space.

What is claimed is:

1. An estimation device comprising:
a storage section capable of storing a model formed through a machine learning;
an estimator capable of estimating a skeleton location of a specific part of a vehicle-occupant in a vehicle interior and a positional relation between equipment in the vehicle interior and the specific part, from image data containing an image of the equipment with an aid of the model;
a likelihood calculator capable of calculating a likelihood of skeleton location information indicating the skeleton location based on the estimated positional relation; and
an output section capable of outputting the skeleton location information.

2. The estimation device according to claim 1, wherein the model is formed through a deep learning using a neural network.

3. The estimation device according to claim 1, wherein the output section outputs likelihood information indicating the likelihood calculated by the likelihood calculator in addition to the skeleton location information.

4. The estimation device according to claim 1, wherein the skeleton location information output from the output section has the likelihood stronger than a given value.

5. The estimation device according to claim 1,
wherein the equipment is one of a plurality pieces of equipment in the vehicle interior,
wherein the estimating section estimates a plurality of positional relations indicating positional relations each between respective one of the plurality pieces of equipment in the vehicle interior and the specific part, and
wherein the likelihood calculator calculates the likelihood of the skeleton location information based on the plurality of estimated positional relations.

6. The estimation device according to claim 5, wherein when the plurality of positional relations has a contradiction, the likelihood calculator compares the plurality of positional relations with positional relations determined based on equipment information indicating respective positions of the plurality of equipment and the skeleton location information, respectively, to calculate the likelihood of the skeleton location information.

7. The estimation device according to claim 1, wherein the likelihood calculator compares the estimated positional relation with a positional relation determined based on equipment information indicating a position of the equipment and the skeleton location information, to calculate the likelihood of the skeleton location information.

8. The estimation device according to claim 1, further comprising a sensing section capable of sensing a state of the vehicle-occupant based on an output from the output section.

9. An estimation method comprising:
obtaining image data containing an image of equipment in a vehicle interior;
estimating a skeleton location of a specific part of a vehicle-occupant in the vehicle interior and a positional relation between the equipment and the specific part, from the obtained image data with an aid of a model stored in a storing section;
calculating a likelihood of skeleton location information indicating the skeleton location based on the positional relation estimated; and
outputting the skeleton location information.

10. A storage medium for storing an estimation program to be executed by a computer of an estimation device, and the storage medium being a non-transitory storage medium,
wherein the estimation program causes the computer to execute:
obtaining image data containing an image of equipment in a vehicle interior,
estimating a skeleton location of a specific part of a vehicle-occupant in the vehicle interior and a positional relation between the equipment and the specific part, from the obtained image data with an aid of a model stored in a storage section,
calculating a likelihood of skeleton location information indicating the skeleton location based on the positional relation estimated, and
outputting the skeleton location information.
